(19) United States
(12) Patent Application Publication
(10) Pub. No.: US 2024/0118105 A1
(43) Pub. Date: Apr. 11, 2024

(54) NAVIGATION METHOD AND COMPUTER-READABLE STORAGE MEDIUM

(71) Applicant: Airbus Defence and Space GmbH, Taufkirchen (DE)

(72) Inventor: Christian Pausinger, Taufkirchen (DE)

(21) Appl. No.: 18/466,653

(22) Filed: Sep. 13, 2023

(30) Foreign Application Priority Data
Oct. 7, 2022 (DE) 102022210634.2

(51) Int. Cl. G01C 21/00

(52) U.S. Cl. CPC G01C 21/3867

(57) ABSTRACT

A navigational method including determination of a position of an object to be navigated as a combination of three coordinates and a representation of the determined position on a digital map, wherein the map has a plurality of predefined spatial segments (110), wherein each of the plurality of predefined spatial segments (110) is determined by a volume and a distinct combination of three coordinates.

### RELATED APPLICATION

This application incorporates by reference and claims priority to German patent application DE 102022210634.2, filed Oct. 7, 2022.

### TECHNICAL FIELD

The present invention concerns a navigation system as well as a computer-readable storage medium.

### BACKGROUND

Computer-aided navigation of objects, especially vehicles, is used in many areas, be it in the private or commercial environment. Especially for companies that deal with the transport of goods or passengers, it is of great importance to identify the best possible routes for this transport. However, the shortest route is not always the best, as the nature of the immediate vicinity of the object to be navigated can have an impact and taking this condition into account involves a certain amount of computational effort.

This is particularly the case for the navigation of aircraft, whether manned or unmanned, since, unlike land vehicles, they can usually move freely in three-dimensional space and are not tied to roads or the like. Navigation in a two-dimensional projection of three-dimensional space is sufficient for many applications, but precise consideration of three-dimensional space has so far been associated with high demands on computing power and memory capacity.

Against this background, the present invention may be embodied as enabling a simplified method for navigation, especially in three-dimensional space, which keeps the requirements for computing power and memory capacity low.

Accordingly, a navigation method is provided. The navigation method involves determining the position of an object to be navigated as a combination of three coordinates, and a representation of the determined position on a digital map. The map has a plurality of predefined spatial segments, wherein each of the plurality of predefined spatial segments is determined by a volume and a distinct combination of three coordinates.

In addition, a computer-readable storage medium is provided. The computer-readable storage medium contains commands which, when executed by a computer, cause it to carry out a method according to the invention.

The present invention may be embodied to divide the real space to be navigated into discrete spatial segments on a digital map, wherein the spatial segments can be clearly distinguished from each other. As a result, the position of the object to be navigated can be clearly assigned to one of these spatial segments and all other calculations necessary for navigation can be carried out in the context of this plurality of spatial segments. Since the positions and relationships of the spatial segments, especially relative to each other, are known in advance, the necessary calculations are advantageously simplified, which reduces the requirements for computing and memory capacity.

In this context, the term “volume” is intended to refer to both the shape and the volume content of the corresponding spatial segment. In particular, the spatial extent of the spatial segment should be clearly defined for the present invention. The coordinates used both for the position of the object to be navigated and for the individual spatial segments can be specified as Cartesian coordinates, radial coordinates, especially with reference to the centre of the earth, or geographical coordinates.

Advantageous designs and developments result from the further dependent claims as well as from the description with reference to the figures.

According to a development, the volume of each of the plurality of spatial segments can be in the form of a cuboid, especially of a cube. This form is particularly advantageously suitable for dividing the space under consideration into clearly distinguishable spatial segments.

According to a development, the volume of all of the plurality of spatial segments can be identical. This can advantageously simplify the effort for various calculations concerning the individual spatial segments.

According to another exemplary embodiment, at least one of the plurality of spatial segments may have a different volume than at least one other of the plurality of spatial segments. This embodiment can be advantageous if the space under consideration has very different areas, such as more rural and more urban areas, for which different “resolutions” are necessary. Increased memory consumption due to using the highest possible resolution can thus be avoided.

According to a development, at least one group of adjacent spatial segments may have a similar, in particular identical, volume. This represents a particularly advantageous compromise between the advantages of the two previous developments.

According to another exemplary embodiment, the volumes and coordinates of the plurality of spatial segments can be formed in such a way that the plurality of spatial segments fills the entire space. This advantageously ensures that every conceivable position of the object to be navigated can be assigned to one of the plurality of spatial segments.

According to a further exemplary embodiment, each of the plurality pf spatial segments can be assigned further information, in particular regarding the presence of situation-relevant objects. As a result, the nature of the environment of the object to be navigated can be advantageously considered.

According to another exemplary embodiment, the navigation method may also include a display of information important to navigation in the corresponding spatial segments of the map. This enables a user of the navigation method to be provided with advantageously detailed information.

According to another exemplary embodiment, the navigation method may also include determining a destination and a route to the determined destination for the object to be navigated, as well as plotting the determined destination and the determined route on the map. This enables a user of the navigation method to be provided with advantageously detailed information.

The above designs and developments can be combined with each other as desired if it makes sense. Further possible embodiments, developments and implementations of the invention also include combinations of features of the invention that are not explicitly mentioned above or described below with regard to the exemplary embodiments. In particular, the person skilled in the art will also add individual aspects as improvements or additions to the respective basic form of the present invention.

### SUMMARY OF FIGURES

The present invention is explained in more detail below on the basis of the exemplary embodiments indicated in the schematic figures. In the figures:

FIG. 1 shows a schematic flowchart of a navigation method based on an exemplary embodiment of the present invention;

FIGS. 2a and 2b show schematic representations of a digital map as well as a plurality of spatial segments for a navigation method according to an exemplary embodiment of the present invention;

FIG. 3 shows a schematic representation of a plurality of spatial segments for a navigation method according to an exemplary embodiment of the present invention; and

FIGS. 4a to 4c show a schematic representation of a specific application example for a navigation method based on an exemplary embodiment of the present invention.

### DETAILED DESCRIPTION

The accompanying figures are intended to provide a further understanding of the embodiments of the invention. They illustrate embodiments and are used in the context of describing the explanation of principles and concepts of the invention. Other embodiments and many of the advantages mentioned arise with regard to the drawings. The elements of the drawings are not necessarily shown to scale in relation to each other.

In the figures of the drawing, elements, features and components that are the same, have the same function and have the same effect,—unless stated otherwise, are each provided with the same reference signs.

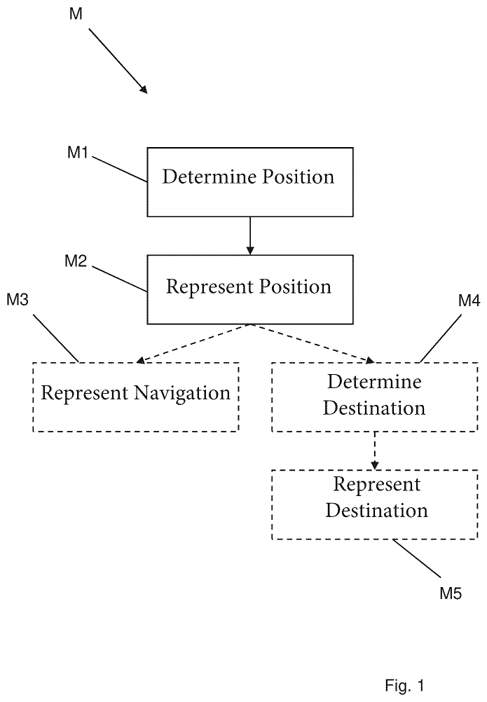

FIG. 1 shows a schematic flowchart of a navigation method M based on an exemplary embodiment of the present invention.

In a first step M1, a position of an object to be navigated is determined, such as using three coordinates (height or altitude, longitude and latitude) in real space. In a second step M2, the determined position of the object to be navigated is plotted on a digital map. The map has a plurality of predefined spatial segments, wherein each of the plurality of predefined spatial segments is determined by a volume and a distinct combination of three coordinates.

In a further optional step M3, information that is important for navigation is displayed in the corresponding spatial segments of the map. In another optional step M4, a destination and a route for the object to be navigated to the destination are determined. In a further optional step M5, the determined destination and the determined route are displayed on the map. The optional steps M3, M4 and M5 are shown with dashed lines.

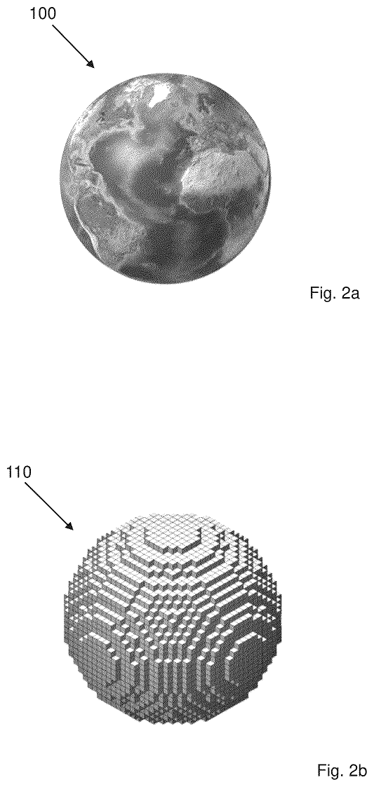

The steps of the method, in particular with regard to the characteristics of the digital map used, are explained in more detail below with reference to FIGS. 2a to 4c.

FIG. 2a shows a schematic representation of a digital map 100 for a navigation method based on an exemplary embodiment of the present invention. FIG. 2b shows a schematic representation of a plurality of spatial segments 110 for a navigation method according to an exemplary embodiment of the present invention.

The digital map 100 shown in FIG. 2a represents the entire surface of the earth. For other application examples, the digital map 100 may also represent only a portion of the surface of the earth, depending on the computing power and data capacity of the computing device used to display the corresponding map 100. As shown in FIG. 2b, the digital map 100 of the surface of the earth may have a plurality of predefined spatial segments 110, which are cubes in the case shown, wherein each part of the surface of the earth can be uniquely assigned to a corresponding spatial segment. The subdivision into spatial segments shown in FIG. 2b is designed very coarsely for reasons of clarity. In a real-world exemplary embodiment, the predefined spatial segments have a much smaller volume, in such a way that multiple spatial segments are provided for each point on a two-dimensional projection of the surface of the earth and are arranged at different heights above the surface of the earth. This also takes into account the fact that the surface of the earth is not perfectly flat but has different heights above sea level at different points.

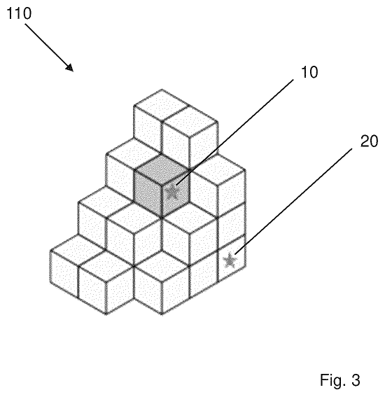

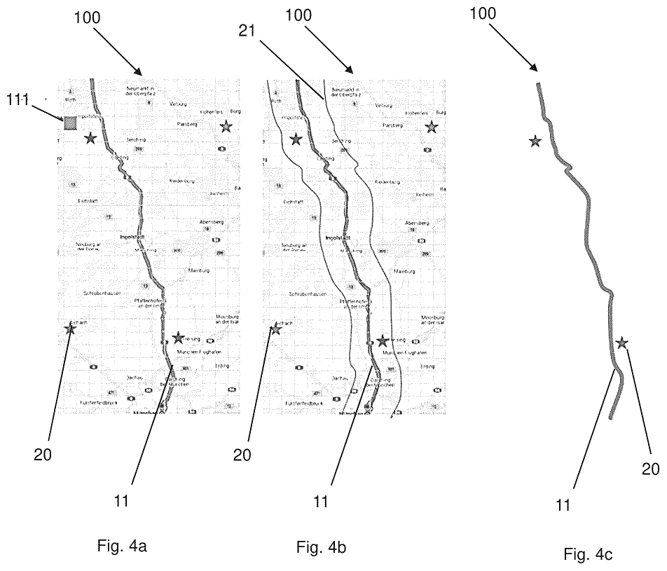

The more detailed functionality of the plurality of predefined spatial segments is explained in more detail below with reference to FIGS. 3 and 4a to 4c.

FIG. 3 shows a schematic representation of a plurality of spatial segments 110 for a navigation method according to an exemplary embodiment of the present invention.

The spatial segments 110 are shown in the form of identical cubes, which are arranged in a three-dimensional arrangement. A position 10 of an object to be navigated, represented here by a star, can be uniquely assigned to one of the spatial segments. Due to the regular arrangement of the plurality of predefined spatial segments 110, it is easy to determine which of the plurality of predefined spatial segments 110 are close to the spatial segment assigned to the position 10 of the object to be navigated. This also makes it easy to decide whether any information assigned to the individual segments of the plurality of spatial segments 110 is relevant, for example with regard to a position 20 of another object, for the navigation method that is using the digital map 100. An exemplary embodiment of this is explained in more detail below with reference to FIGS. 4a to 4c.

FIGS. 4a to 4c show a schematic representation of a specific application example for a navigation method based on an exemplary embodiment of the present invention.

The digital map shown in FIGS. 4a to 4c has a plurality of predefined spatial segments, one of which 111 is highlighted for illustrative purposes. Due to the two-dimensional projection of the view, the spatial segments appear here as squares, but are actually cubical. The navigation method described here is a route planning method for a delivery vehicle.

In FIG. 4a, a route 11 is shown that a delivery vehicle is travelling on a return trip after a successful delivery. The delivery vehicle is unladen at this time, so it could take on more cargo. The positions 20 of loads that are waiting for further transport can be clearly assigned to specific spatial segments. However, the delivery vehicle should not take too much of a detour to pick up loads. This means that not all loads waiting for onward transport are even eligible for the delivery vehicle.

In FIG. 4b, it is shown that boundaries 21 can define how far the delivery vehicle can deviate from the determined route 11. It is now easy to determine which positions of loads waiting for onward transport are eligible for the delivery vehicle, since there is no need to determine a distance to the route 11, but only to compare which of the spatial segments assigned to positions 20 of the loads are within the acceptable area. These selected positions 20 can then be displayed in addition to the route, as shown in FIG. 4c.

In FIGS. 4a to 4c, an application example for a ground-based vehicle was chosen, as this is easier to depict figuratively. However, the advantages of the present navigation method, in particular the use of three-dimensionally arranged spatial segments, arise in a special way when considering aircraft, since the height at which the object to be navigated is located is also important here, especially since, for example, distance determinations in three-dimensional space require more computational effort than on two-dimensional projections of the surface of the earth. For example, the method presented here can be used to compare the specific flight route of an aircraft with known routes of other aircraft, since instead of a time-consuming distance determination it is only necessary to check at which points in a pre-known three-dimensional arrangement the spatial segments assigned to the respective routes are arranged in order to ensure that a distance that reduces the risk of collisions is maintained.

The use case shown in FIGS. 4a to 4c of a selection of loads waiting for a delivery vehicle for onward transport can also be applied to aircraft, especially to small, unmanned aerial vehicles, such as drones, which move in more urban areas. In such spaces, the routes that a drone can follow can be very complex, which makes it very difficult to determine the length of a deviating route for collecting more loads. With the present method, it is easy to determine which routes are eligible, since “passability of the spatial segment” can be an example of further information that may be relevant for navigation, which can be assigned to each of the spatial segments. To determine the length of the route, it may then be sufficient to count how many of the predefined spatial segments have to be crossed, since the spatial extent of each spatial segment is known in advance. The shortest possible route is then determined by selecting the route that crosses the fewest spatial segments without crossing an impassable spatial segment.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both, unless the this application states otherwise. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### REFERENCE SIGN LIST

M Navigation method
M1 Step of determining a position
M2 Step of plotting a position
M3 Step of presenting information
M4 Step of determining a destination and a route
M5 Step of presenting a destination and a route
100 Map
110 Plurality of spatial segments
111 Spatial segment
10 Position of an object
11 Route
20 Position of an object
21 Boundary

1. A navigation method including:
a determination of a position of an object to be navigated as a combination of three coordinates; and
a representation of the determined position on a digital map;
wherein the map has a plurality of predefined spatial segments, wherein each of the plurality of predefined spatial segments is determined by a volume and a distinct combination of three coordinates.

2. The navigation method according to claim 1, wherein the volume of each of the plurality of spatial segments is in a form of a cuboid.

3. The navigation method according to claim 1, wherein the volume of all of the plurality of spatial segments is identical.

4. The navigation method according to claim 1, wherein at least one of the plurality of spatial segments has a volume different than the volume of at least one other of the plurality of spatial segments.

5. The navigation method according to claim 4, wherein at least one group of adjacent spatial segments in the plurality of spatial segments have similar volumes.

6. The navigation method according to claim 1, wherein the volumes and the coordinates of each of the plurality of spatial segments are arranged such that the plurality of spatial segments fills an entire space.

7. The navigation method according to claim 1, wherein each of the plurality of spatial segments is assigned further information concerning a presence of situation-relevant objects.

8. The navigation method according to claim 7, further including a representation of information important to navigation in the corresponding spatial segments of the map.

9. The navigation method according to claim 1, further including a determination of a destination and a route to the determined destination for the object to be navigated and a representation of the determined destination and the determined route on the map.

10. A computer-readable storage medium containing commands which, when executed by a computer, cause the computer to carry out the method of claim 1.

11. A navigation method using a digital map representing real space by predefined spatial segments each having a volume and location corresponding to a unique a position on the digital map:
determining a position in real space of an object to be navigated,
identifying one of the spatial segments on the digital map corresponding to the position of the object, and
using the identified spatial segment to represent the position of the object on the digital map.

12. The navigation method of claim 11, wherein the object is a vehicle.

13. The navigation method of claim 11, further comprising navigating the object using the identified spatial segment.

14. The navigation method according to claim 11, wherein each of the spatial segments has a cuboid shape.

15. The navigation method according to claim 11, wherein the volume of each of the spatial segments is identical.

16. The navigation method according to claim 11, wherein the volume of least one of the spatial segments differs from the volume of another one of the spatial segments.

17. The navigation method according to claim 11, wherein a group is defined of the spatial segments adjacent to at least one other of the spatial segments in the group, and each of the spatial segments in the group has a uniform volume.

18. The navigation method according to claim 11, wherein the volumes and the coordinates of each of the spatial segments are arranged such that the plurality of spatial segments fills on the digital map the real space represented by the digital map.

19. The navigation method according to claim 11, further comprising assigning to a plurality of the spatial segments an indicator of a presence other objects.

20. The navigation method according to claim 11, further comprising:
determining a destination and a route to the determined destination for the object to be navigated and
identifying the spatial segments on the digital map corresponding to the destination and route.
